(19) United States
(12) Patent Application Publication
(10) Pub. No.: US 2010/0130340 A1
(43) Pub. Date: May 27, 2010

(54) METHOD AND DEVICE FOR CONTAMINATION FREE LOADING AND EMPTYING

(76) Inventor: Richard Denk, Scheyern (DE)

Correspondence Address: HEAD, JOHNSON & KACHIGIAN, 228 W 17TH PLACE, TULSA, OK, 74119, US

(21) Appl. No.: 12/449,831

(22) PCT Filed: Feb. 26, 2008
(86) PCT No.: PCT/EP2008/052301

§ 371 Date: Jan. 4, 2010

(30) Foreign Application Priority Data
Feb. 28, 2007 (DE) 10 2007 009 681.1
Aug. 16, 2007 (DE) 10 2007 038 692.5

(51) Int. Cl. B04B 7/16; B04B 3/00; B04B 7/06

(52) U.S. Cl. 494/12; 494/36; 494/27; 494/26; 494/37

(57) ABSTRACT

The invention relates to devices and equipment which need to be loaded and emptied contamination free, in particular it relates to a centrifuge or to a mixer. Thereby, also toxic substances shall be centrifuged with comparatively low complexity, and the centrifuge shall subsequently be emptied and prepared for further use. This is accomplished by closing the open side of the drum housing configured with the drum insert and/or of the drum insert and/or of the drum with a disposable cover.

### I. FIELD OF THE INVENTION

The invention relates to devices and machinery which need to be loaded and emptied contamination free, in particular it relates to a centrifuge or to a mixer.

### II. TECHNICAL BACKGROUND

In particular in the pharmaceutical industry, but also in the chemical industry, substances often need to be handled frequently, which include toxic substances, e.g. they have to be centrifuged, mixed or dried.

Thus, the problem is that though the centrifuge can be tightly sealed during centrifuge operation, and thus no toxic or other undesired substances can leak from the centrifuge to the outside, however, at the latest, when opening the centrifuge for removing e.g. the filter cake, the filter cloth or residual quantities, the environment is contaminated.

Thus, these machines, subsequently only centrifuges are being described, though the invention is not limited to them, are housed in rooms, which in turn are sealed completely tight relative to the ambient, in order not to let contaminations exiting from the centrifuge into the space surrounding centrifuge permeate further to the outside into the environment.

This, however, significantly increases the ensuing complexity, e.g. for centrifuging such substances, since not only the centrifuge itself needs to be cleaned after centrifuging, but also the centrifuge cavity, in which the centrifuge was disposed, when the centrifuge was opened and emptied after its operation.

### III. DESCRIPTION OF THE INVENTION

### a) Technical Object

Thus, it is the object of the invention to provide an apparatus, like e.g. a centrifuge and a method for its operation, by means of which also toxic substances can be centrifuged with comparatively low complexity, and the centrifuge can be emptied subsequently and prepared for further use.

### b) Solution

Said object is accomplished through the features of claims 1 and 14. Advantageous embodiments can be derived from the dependent claims.

Since the drum of the centrifuge, which can be driven in rotation, comprises at least a partially open side, or a side to be partially opened, and a drum insert providing the sifting function or the filter function, in particular a permanently shaped drum insert, can be inserted into the drum through said opening and moved out of the drum through said opening, thus also together with the residual solid materials, which remain in the drum insert, simpler handling than with the typical filter fleece, which is otherwise deployed in the interior of the drum, is already provided. Also, the integration of a drum and a drum insert is possible in conjunction with the present invention.

Preferably, also the stationary drum housing which encloses the rotating drum, comprises at least a partially open side, in particular a face, which coincides with the open side of the drum, or with the side of the drum to be opened, and is in alignment with said side.

Thus, the open side either of the drum or of the drum insert, preferably, however, of the drum housing, can be closed with a cover with a stable shape or with a bag shaped or hose shaped, though preferably elastic and flexible, foil, which is tight with respect to the suspension and its components, so that no components of the suspension can leak out of the drum housing, which is otherwise provided tight anyhow, besides the inlet for the suspension.

It is important that the drum or the drum insert is tight for the solids of the suspension, besides the inlet, which, however, connects tight to the housing.

Said foil is mounted tight with its open side to the open side of the drum or of the drum housing and closed otherwise, since it is either configured bag shaped or, in case of a hose configuration, the side of the hose at the other end, which is otherwise open, is also sealed tight. Depending on the mounting location, it co-rotates with the drum or the drum insert or it stands still with the drum housing.

When said foil is furthermore sized, so that the drum insert with the solid material left therein can be completely removed out of the drum and out of the drum housing, wherein, however, it still remains within the foil, removing the drum insert with the solid material is possible without leaving the tight space formed by the drum housing and the foil.

When the foil is additionally sized so that a tight closing of the foil is facilitated between the drum housing and the drum insert, e.g. through directly clamping down the hose shaped foil, and subsequent separation at said closing locations or between two such closing locations, then the drum insert with the filter cake is subsequently disposed in a cavity, which is enclosed tight by the foil on all sides, while, on the other hand, the drum housing, which is also contaminated, is still sealed by the remaining rest of the foil, which is also sealed tight.

Thus, it is possible to clean the contaminated interior of the drum insert automatically through a washing- or cleaning device installed therein, thus without having to open it, e.g. through a built in flushing device, so that it is ready for further use thereafter, and so that the closed foil rest can also be removed then.

By the same token, the closed foil bag with the drum insert and the filter cake disposed therein can be emptied without contamination and can subsequently be cleaned either in a separate cavity, which is sealed to the outside relative to the ambient, and provided in particular for said purpose, or even better, through tight placement of the closed end of the foil onto a respective outlet spout.

Among other things, care must be taken that the freely extending foil spout, which may otherwise be created when cutting foil off, wherein the inner surfaces of the foil of said spout can also be contaminated, either initially remains closed tight, or it is cleaned separately.

It is another option to keep the inner surfaces of said foil spout without contamination through additional measures, e.g. through a configuration of the foil, which has plural layers in said location, and through pulling the contaminated inner foil off from the foil, which tightly seals in said separation area, so that the inner surfaces of the foil cannot be contaminated in the separation area either.

Additionally, the filter cake can be dried in the insert, which is still disposed in the drum housing and in the drum, before removing the drum insert, and thus the filter cake can in turn be dried without contamination, thus through supplying dry air and/or heat into the interior of the drum housing, e.g. through the opening in the drum housing, which is provided as an outlet for the liquid.

After contamination free emptying of the drum insert, the foil should still be long enough, so that a renewed tight closing of the foil between the outlet spout and the drum insert is facilitated. This way, the empty drum insert can be received again in a so foil, which is closed tight on all sides, and can thus be either provided to a special cleaning system or to a disposal system.

The bag shaped residual foil, which remains on the drum housing, can also be removed without contamination, thus after automatic cleaning of the drum housing, and thus after cleaning said residual foil from the inside, since a cover hood can be placed onto the open side of the drum housing still provided with the residual foil, and a disposal opening is provided in said cover hood, which is in turn enclosed tight by a disposal bag made of tight foil.

The disposal bag can be put over from the outside like a glove towards the inside through the disposal opening, and when the disposal opening is positioned accordingly, the residual foil, which is located on the drum housing, is grasped by means of said glove, pulled off from the drum housing, possibly after opening the mount of the residual foil at the drum housing, and can be pulled out of the cover hood into the interior of the disposal bag.

Said disposal bag is then closed tight between the received residual foil and separated, whereby the residual foil, which may still be contaminated, is in turn provided tightly sealed in the disposal bag.

In the same manner, also all other residual foils, e.g. residual foils remaining on the outlet spout, can be disposed of analogously.

Accordingly, in order to perform said method, a centrifuge should, on the one hand, comprise an inlet opening in the drum insert, which inlet opening can be placed tight onto the inlet spout of the drum housing, in order to prevent that suspension, which has not yet been centrifuged, reaches the space outside of the drum insert.

By the same token, the drum insert should preferably be a reusable drum insert, which can be inserted again after contamination free emptying and subsequent cleaning.

The employed foil should preferably be hot sealable, in order to perform a separation at the closing location simultaneously with providing the melt joint, and thereby being able to prevent contaminants from leaking.

The rotation axis of the drum is disposed horizontal in a preferred embodiment and the open side of the drum or the open side of the drum housing is a face, and thus the face opposite to the drive side.

In order for the foil to be connectable tight and still disengageable with the drum housing at the centrifuge side end, a clamping device which is configured accordingly is useful.

The outlet in the drum housing for the centrifuged liquid should preferably be switchable to the supply of drying air. By the same token, a washing device should be provided within the drum housing, in particular a flushing device, in order to be able to clean the interior of the drum housing, and thus also the rotating drum itself, automatically as far as possible.

The above described method can be performed in a particularly simple manner, when the length of the hose shaped or bag shaped foil required for the described method is not only applied to the drum housing once, but applied several times, and can be pulled off from there as required.

When a protective hood is provided, which fits tight onto the drum housing, primarily in order to prevent the fly-off of objects or components, said protective hood should comprise a disposal opening, which comprises an outward protruding spout for folding a disposal bag over, and which is disposed, so that a fist can be put through.

### c) Embodiments

Embodiments of the invention are subsequently described in more detail in an exemplary manner with reference to drawing figures, wherein:

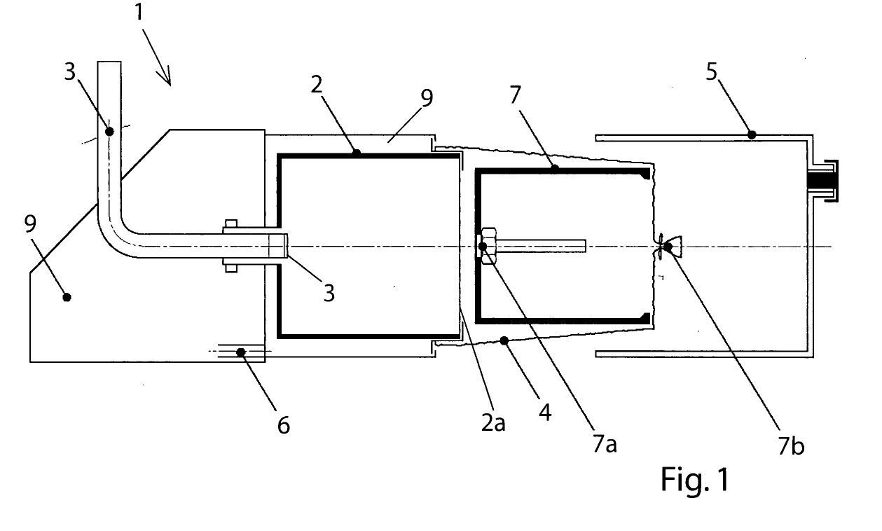

FIG. 1 shows the centrifuge during assembly into operating condition;

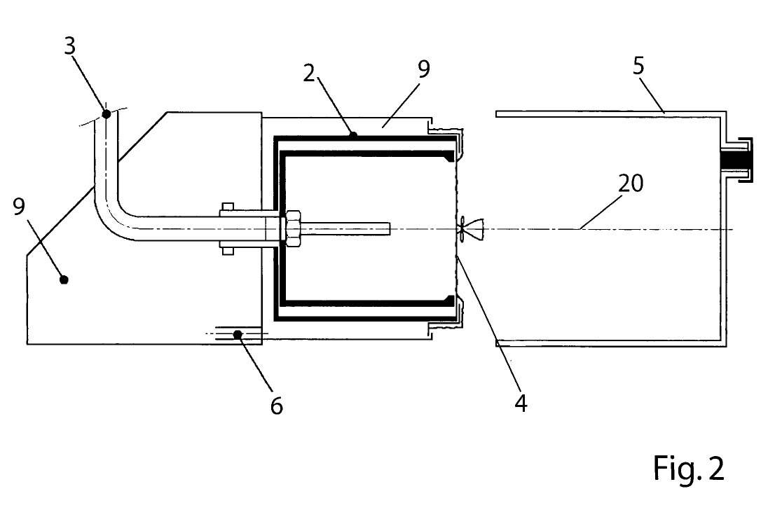

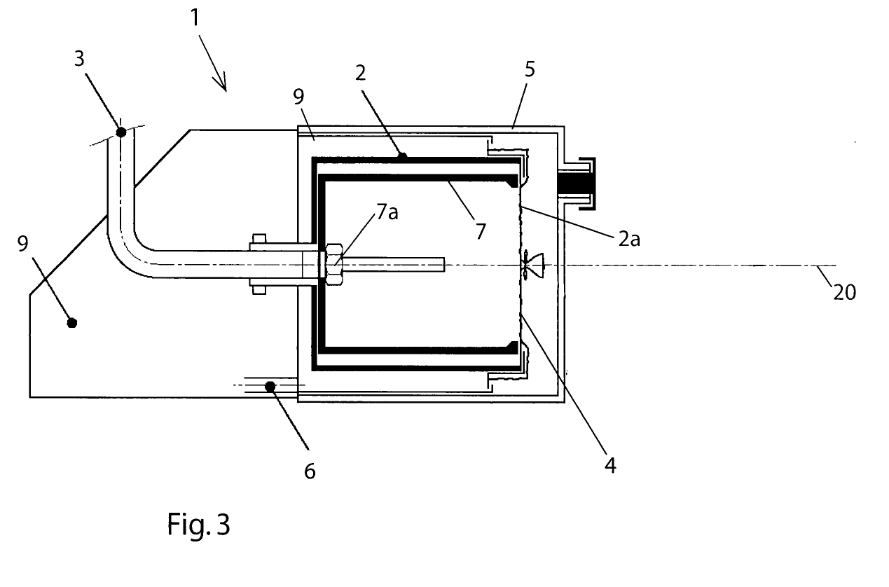

FIG. 2 shows the centrifuge in operating condition with the cover hood open;

FIG. 3 shows the centrifuge with the cover hood closed;

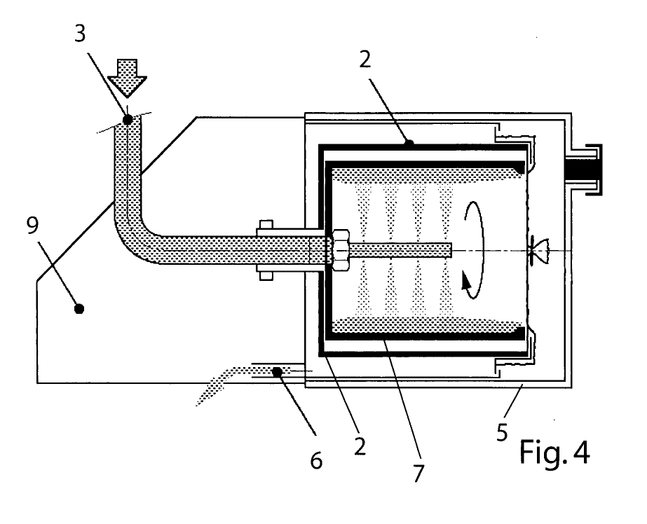

FIG. 4 shows the centrifuge during centrifuge operation;

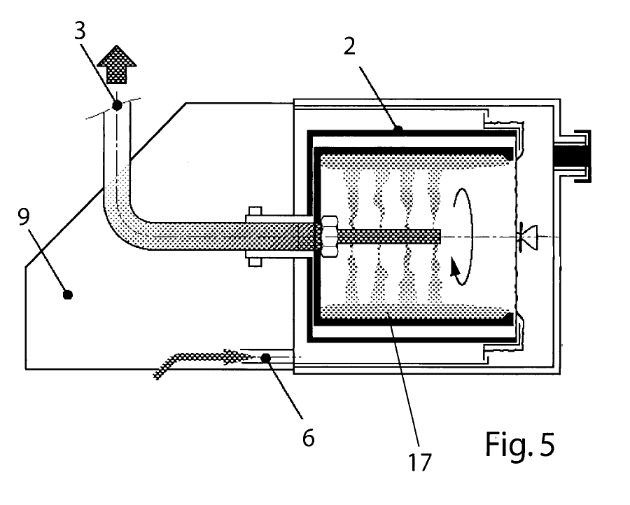

FIG. 5 shows the centrifuge during drying;

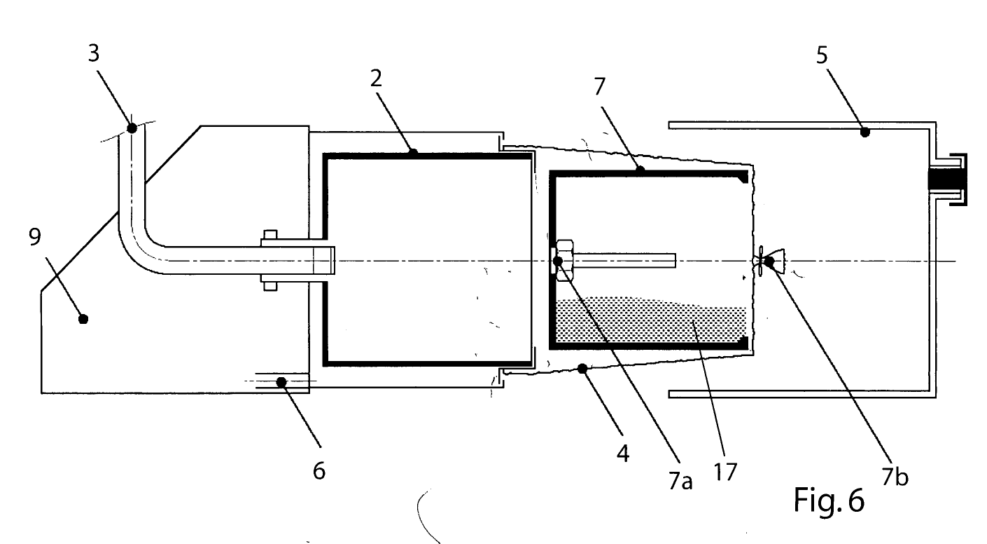

FIG. 6 shows the centrifuge with the drum insert pulled out of the drum;

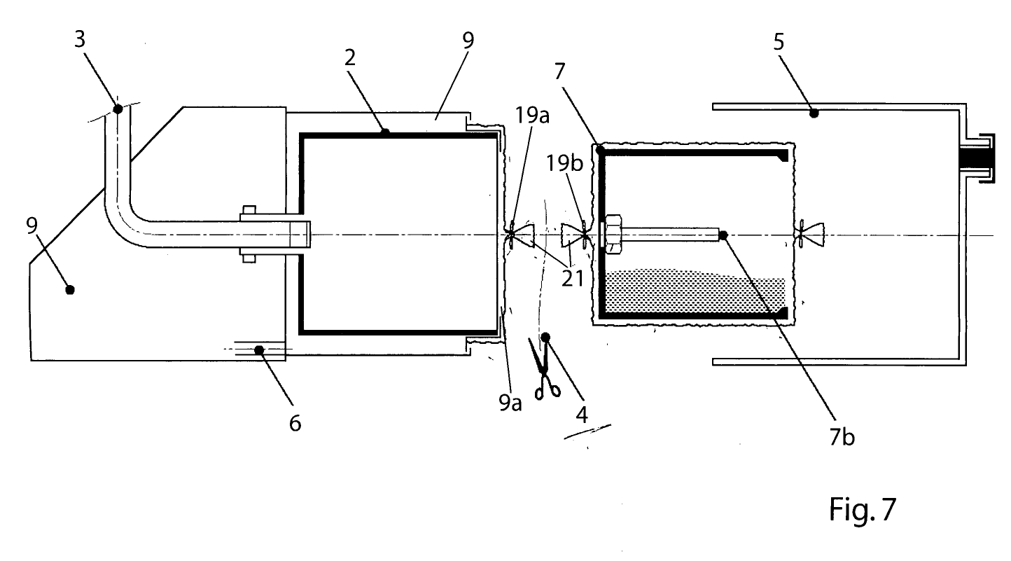

FIG. 7 shows the centrifuge with the drum insert removed;

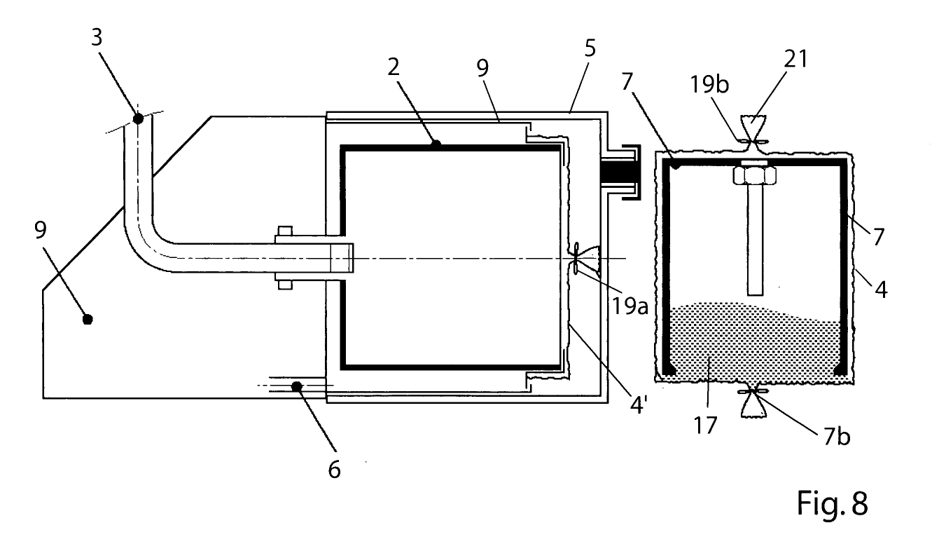

FIG. 8 shows the centrifuge with a vertically disposed separate drum insert;

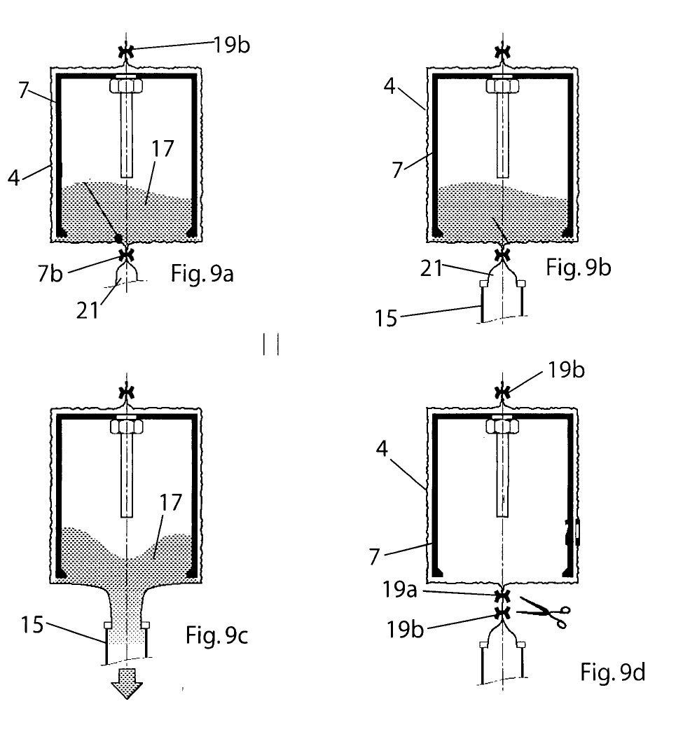

FIG. 9 shows the emptying process of the drum insert; and

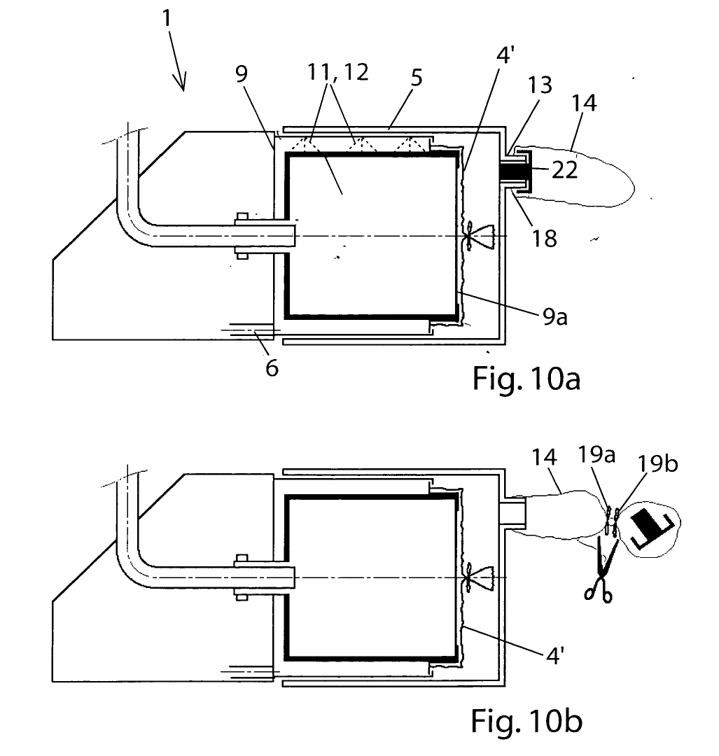

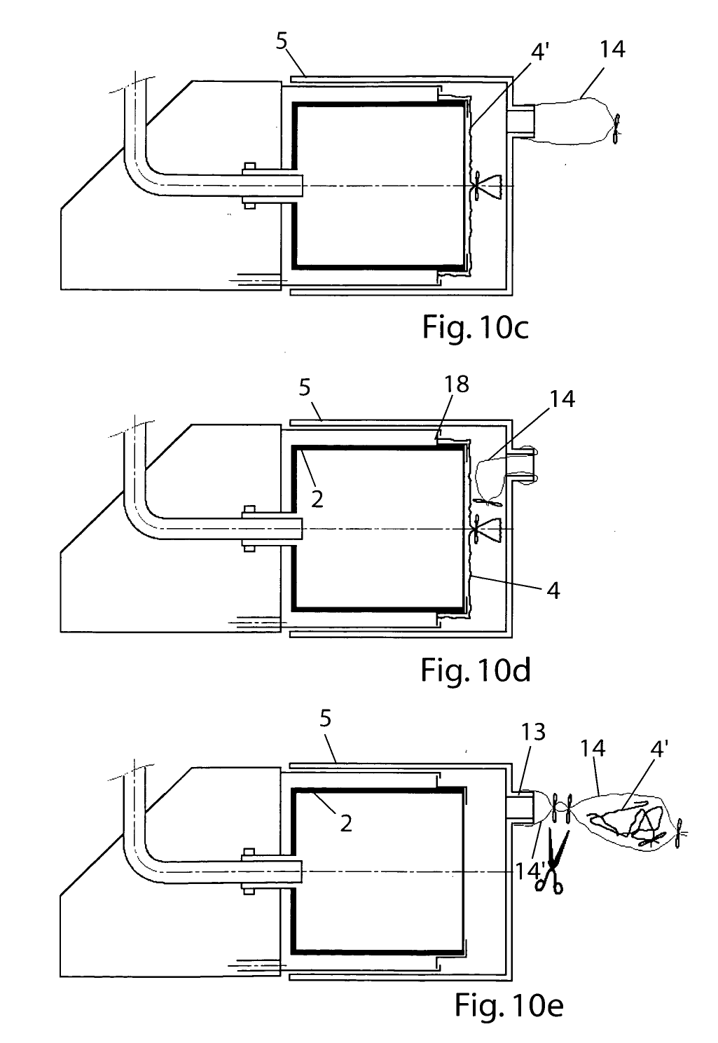

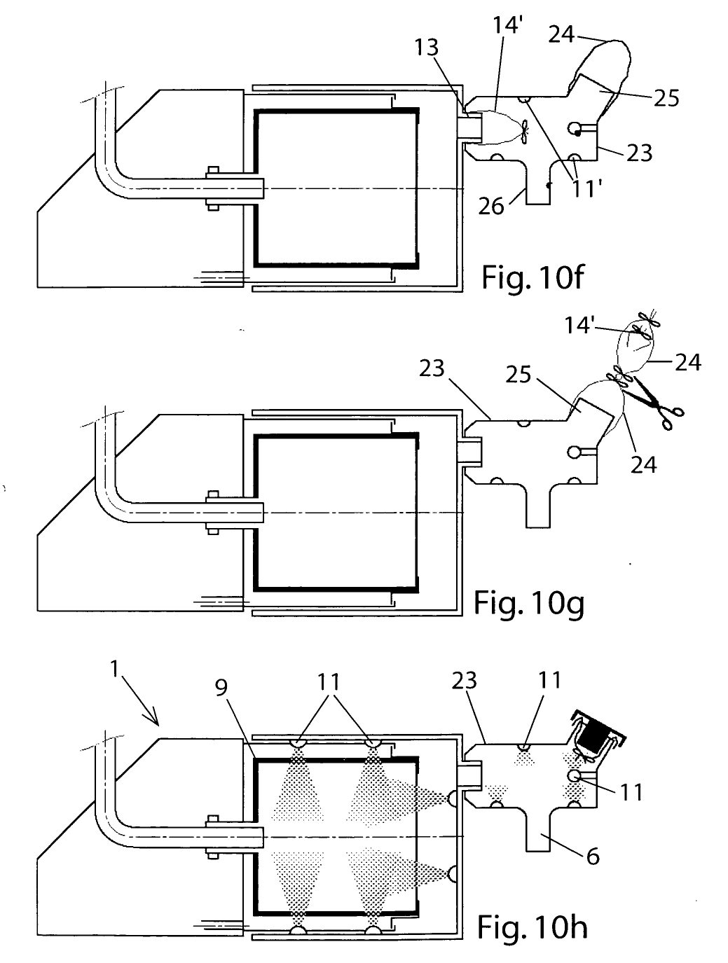

FIG. 10 shows removing the residual foil from the drum housing.

The centrifuge is initially described best with reference to its complete operating condition according to FIG. 3.

The centrifuge 1 comprises a fixed drum housing 9, in which the drum 2, which is drivable in rotation, is supported. In this case, the drum 2 is supported with a horizontal rotation axis 20, floating on one side in the drum housing 9, so that the drum 2, as well as the drum housing 9, in this case the right face 2a, e.g. of the drum, are correspondingly configured as the open side.

The inlet 3 for the suspension leads into the left, closed side of the drum 2, which suspension shall be separated into a solid and a liquid through centrifuge operation.

Within the drum 2, there is a form stable, cylindrical, preferably reusable, drum insert 7, which provides the necessary filter function, which is permeable for liquid, in particular at its enveloping surfaces, but which is not permeable for solids included in the suspension, and which co-rotates with the drum 2 during operation.

The drum insert 7 comprises a connection spout 7a in its left face, which connection spout fits tight onto the inlet spout 3 of the housing, and which protrudes into the drum 2 on the rotation axis 20.

The connection spout 7a of the drum insert 7 protrudes from the left face over approximately two thirds of the axial length of the drum insert 7 on its rotation axis 20 forward and preferably comprises outlet openings at its circumferential surfaces in order to let the suspension exit into the drum insert 7, distributed over its axial length.

In the drum housing 9, an outlet 6 is furthermore visible in the lower portion, which outlet is used for draining the liquid from the drum housing 9, which liquid has leaked through the drum insert 7 to the outside.

A cover hood 5, which fits tight on the open side of the drum housing 9, is put over from the open side, thus from the right like a cap over the open side 9a of the drum housing 9 in order to capture components flying off, thus components coming loose from the drum or similar during operation, when the drum 2 rotates at high speed, in order to prevent damages, and in particular injuries to people, in the vicinity of the centrifuge.

FIG. 1 shows the assembly of the centrifuge for the method according to the invention into operating condition.

The drum insert 7 is still disposed axially outside of the drum 2 and thus of the drum housing 9, though it is positioned shortly before its open side 2a.

A bag shaped foil 4 is mounted at the drum housing 9 at its outer circumference proximal to the open side 9a, which foil extends axially from the open side 9a of the drum housing 9, so that the drum insert 7 is completely received in said foil 4.

The foil 4 is closed tight at its other end thus at the side of the drum insert 7, which faces away from the centrifuge 1 and its open side, and comprises a product outlet 7b at this location, which can be opened.

Accordingly, the cover hood 5 is not yet put over the open side of the drum housing 9 either.

In FIG. 2, the drum insert 7 is already axially inserted into the drum 2 completely and sits tight on the inlet 3 of the centrifuge with the inlet of its inlet spout 7, which inlet leads into the center of the drum 2.

The foil 4 is axially approximated to the open side of the drum housing 9, so that it does not form a significant overhang anymore, but so that it does not contact the components subsequently rotating during operation, thus neither the drum 2 nor the drum insert 7, and cannot rub thereon either, which is assured when necessary by the respective axial pullover of the superfluous portion of the foil 4 onto the outer circumference of the drum housing 8 or by other measures.

In FIG. 3, contrary to FIG. 2, the cover hood 5 is also already axially put over the drum housing 9 from its open side 9a, so that the centrifuge is ready for operation now.

FIG. 4 shows the centrifuge during operation.

The drum 2 and the drum insert 7 rotate synchronously about their common horizontal rotation axis 20, while the suspension to be centrifuged reaches the interior of the drum insert 7 through the inlet 3 and the connection spout 7a of the drum insert 7 and through its radial openings.

Therein, the suspension is pressed against the inner sides of the enveloping surfaces of the drum insert 7, wherein the liquid components can pass radially through the enveloping surfaces of the drum insert 7 to the outside into the drum housing, where they collect at the deepest spot due to gravity and where they are drained through the outlet 6, disposed at said location.

FIG. 5 shows the condition after centrifuging.

A filter cake 17 has formed at the insides of the enveloping surfaces of the drum insert 7, which filter cake still comprises a relatively high residual humidity.

In order to dry said filter cake 17, dry, in particular heated, air is pressed into the drum housing 9, possibly in a drying step through the outlet 6, while the drum 2 and the drum insert 7 continue to rotate possibly at a reduced speed, however, so that the filter cake 17 still contacts the inner surfaces of the drum insert 7.

Drying air thus permeates the filter cake from the outside to the inside and thus removes humidity from the filter cake 17.

The drying air loaded with humidity is extracted through the outlet spout 7a of the drum insert 7 and from there through the inlet 3 of the centrifuge 1. When the filter cake 17 is dried sufficiently, the rotation of the drum 2 and of the drum insert 7 is halted, thereafter the filter cake 17 falls down from the upper portions of the drum insert 7 and collects at its lowest point.

FIG. 6 shows how the filter insert 7 with the filter cake 17 included therein is axially pulled out of the open side 9a of the drum housing 9, and thus is also pulled out of the drum 2, however, while still disposed tightly enclosed within the foil 4, which can assume a sufficiently sized axial extension for said purpose, without being separated from its tight fixation at the drum housing 9.

Thus, all toxic material, besides the liquid already removed by the outlet 6, is still disposed in a tightly enclosed space formed on one side by the drum housing 9 and on the other side by the foil 4.

Thus, it is important that the axial extension of the foil 4 is large enough, so that as illustrated in FIG. 7, the foil 4 between the open side 9a of the drum housing 9 and the drum insert 7 disposed in the foil 4 can be moved towards the hose shaped foil 4, disposed there between, whose circumferential portions assume a distance to one another approximately corresponding to the diameter of the drum insert 7 in radial direction towards one another, so that the respective sections of the foil 4 contact one another so that they seal.

Thus, the foil sections are pressed against one another to form at least one, better two, closing location(s) 19a, b, which do not comprise any free passage in axial direction anymore, and the foil sections are kept tight through a suitable closure element, e.g. a pipe clamp or a sufficiently sized cable tie or similar.

Subsequently, the hose shaped foil 4 is separated either between said two closing locations 19a, b, or in case of a sufficient extension of only one closing location, it is separated within the area of said closing location, so that the drum insert 7 received tight in the closed portion of the foil 4 can be moved separately.

By the same token, the inside of the drum housing 9 remains tightly closed on the other side by the residual foil 4′.

Thus, outside of the foil 4 on one side and also outside of the residual foil 4′, thus there are no contaminations caused by the centrifuged material.

The foil spout 21 shown in FIG. 7 is the only problematic point, which is created on both sides between the respective closing location 19a, b and the separation location, at which point the inside of the foil 4, which could be contaminated, is accessible from the outside.

In order to minimize the above, it is proposed in a preferred embodiment to provide the separation location, e.g. within the left closing location 19a, or closely in front of the left closing location 19a, so that separating simultaneously constitutes sealing the cutting surface of the compressed foil hose of the foil 4, which is possible e.g. with thermoplastic foils through separation by means of heat, which simultaneously causes welding the cutting surfaces together, and thus causes sealing.

FIG. 8 shows how, on the one hand, the cover hood 5 is slid onto the drum housing 9, and on the other hand, how the drum insert 7, which is separate now, is placed vertically, thus with the closing location 19b of the foil 4 oriented upward, and thus with the at least partially open face of the drum insert 7 pointing downward, whereupon the filter cake 17 collects at said open lower face.

FIG. 9a shows the product outlet 7b, now disposed at the lower end of the foil 4, and also provided in the form of a foil spout 21, which is long enough in order to be mounted tight according to FIG. 9b at the open end of an outlet spout 15.

After opening the foil spout 21 by loosening the element compressing the foil hose, an opening is created, which is continuously open from the drum insert 7 into the outlet spout 15, but which is sealed towards the outside, through which opening the filter cake 17 falls out of the drum insert into the outlet spout 15, or can be moved back and forth through shaking, etc. until the drum insert 7 is completely emptied.

Then the foil hose of the foil 4 is compressed tight between the drum insert 7 and the outlet spout 15, in turn, preferably at two closing locations 19a, b, and separated there between according to FIG. 9c.

Thus, in turn, the drum insert 7, which now does not contain any filter cake or hardly contains residuals of the filter cake 17, but which is still contaminated, is enclosed tight by the foil 4, and can now be handled and transported separately in turn, it can e.g. be loaded into a separate disposal device (when the drum insert 7 is only used once), or it can be loaded to a washing and decontamination device (when the drum insert 7 is being reused), both of which devices are not shown.

FIG. 10 shows how the foil rest 4′, which has remained in the drum housing 9, and which still encloses said drum housing tight, can be handled.

In FIG. 10a, the cover hood 5 is put over the drum housing 9 from its open side 9a as far as possible, so that the bottom of the cap shaped cover housing 5 rests proximal to the open side 9a of the drum housing 9.

In this bottom, a disposal opening 13 is provided with a spout extending away from the centrifuge 1 on the exterior circumference of said spout, a disposal bag 14 made of flexible sealed foil is mounted, which also protrudes away from the centrifuge, which mounting can be performed by means of a suitable clamping device 18, like when the foil 4 is supported on the outer circumference of the drum housing 9a. The disposal opening is closed by a plug 22, which is inserted from the outside.

Meanwhile, the interior of the drum housing 9 and thus also the drum 2 has been cleaned by means of the flushing device 11 shown in FIG. 10, which flushing device is installed in the interior of the drum housing 9, and which preferably also comprises a spraying device 12, by means of which cleaning fluid can be applied to all inner surfaces of the drum housing 9 and also to the drum 2, which can be slowly driven in rotation for said purpose.

The applied cleaning fluid washes the remaining contaminations off, and is in turn removed through the outlet 6, wherein the cleaning process is continued until the entire interior of the drum housing 9, including the drum 2, is most likely not contaminated anymore, or is only slightly contaminated.

The portion in which residual contaminations can most likely still be found are the inner surfaces of the residual foil 4′, which can form wrinkles or similar due to its non-form stable structure, wherein contaminations may remain in said wrinkles, in spite of the washing process.

Therefore, in particular, said residual foil 4′ has to be reliably disposed of, in spite of the cleaning process performed upon the drum housing 9, without coming into contact with the environment.

For this purpose, as evident in FIG. 10, the disposal bag 14 is used as a glove, in order to remove the plug 22 placed onto the spout within the disposal bag 14, and to move said plug into the rear end of the disposal bag 14.

The disposal bag 14 is sealed tight again at two closing locations between the disposal opening 13 and the enclosed plug 22, and it is separated there between, whereby the possibly contaminated plug 22 is sealed tight.

The disposal bag 14 initially protruding outward is inserted through the disposal opening 13 into the interior of the cover hood 5, and the hand of a user is inserted, which thus uses said disposal bag 14 like a glove.

Thereby, he can grab the residual foil 4′ in the interior of the cover hood 5 using said disposal bag 14 as a glove, as long as said residual foil 4′ is long enough and if necessary, he can also loosen the clamping device 18, by means of which the residual foil 4′ is mounted to the outer circumference of the drum housing 9, when the disposal opening 13 is in a suitable position for said purpose, and when the disposal bag 14 is sized sufficiently long enough (FIG. 10c).

The user now pulls the residual foil 4′ into the interior of the disposal bag 14 by grabbing the residual foil 4′ and pulling his hand back again through the disposal opening 13 together with the residual foil 4′ and the disposal bag 14 towards the outside of the cover hood 5, whereby the residual foil 4′ is completely received within the disposal bag 14 as illustrated in FIG. 10c.

The hose shaped disposal bag 14 is in turn closed between disposal opening 13 and the received residual foil preferably at two closing locations 19a, b, and e.g. separated there between, for tight receiving of the residual foil 4′, thereafter, the portion with the tightly received residual foil 4′ can be handled separately, in particular it can be disposed of safely and without contamination.

In case there is concern that the residual bag 14′ still remaining at the disposal opening 13 is still contaminated, also this residual bag 14′ can be disposed of in another step, as illustrated in FIGS. 10f through 10h.

A decontamination device 23 is placed onto the spout of the disposal opening and also over the residual bag 14, so it fits exact and tight. Said device 23 comprises an engagement opening 25 opposite to the spout 23, on which engagement opening another disposal bag 24 is placed tight. Said device comprises another outlet 26 in its deepest portion, and a flushing device 11′ is disposed in the interior of the device.

According to FIG. 10g, a person reaches into the device with the disposal bag 24 as a glove, and pulls the residual bag 14′ off from the disposal opening 13 and out of the device 23 into the interior of the additional disposal bag 24.

Subsequently, the disposal bag 24 is in turn sealed tight between the engagement opening 25 and the enclosed residual bag 14 and separated, whereby the residual bag 14′ is enclosed tight and can be processed further separately.

Subsequently, the interior of the decontamination device 23 can be flushed separately or also together with the interior of the drum housing 9 by means of the respectively installed flushing devices 11, 11′ and can thus be decontaminated. Used flushing liquid is drained from the drum housing 9 through its outlet 6 and from the decontamination device 23 from its outlet 26.

Thereafter, the centrifuge 1, as well as the decontamination device 23, are available for further use.

### REFERENCE NUMERALS AND DESIGNATIONS

1 centrifuge
2 drum
2a open side
2′ foil
3 inlet suspension
4, 4″ foil
4′ residual foil
5 cover hood
6 outlet
7 drum insert
7a connection spout inlet
7b product outlet
8 clamping device
9 drum housing
9a open side
10 outlet opening
11, 11′ flushing device
12 flushing device
13 disposal opening
14, 14′ disposal bag
15 outlet spout
16 closure
17 filter cake
18 clamping device
19a, b closing location
20 rotation axis
21 foil spout
22 plug
23 decontamination device
24 disposal bag
25 grab-in opening
26 outlet

What is claimed is:

1. A centrifuge (1) with a drum housing (9), said centrifuge comprising:
a side (9a) which is at least partially open;
a drum (2), drivable in rotation therein, with a side (9a), which is at least partially open or which can at least be partially opened; wherein
the drum (2) comprises at least one inlet (3) for a suspension to be centrifuged, wherein desired solids are retained in a liquid permeable, removable, drum insert (7) which fits into the drum (2);
the drum insert (7) comprises an inlet opening for connecting to the at least one inlet (3) of the drum (2); and
the open side (9a) of the drum housing (9) configured with the drum insert (7) and/or of the drum insert (7) and/or of the drum (2) is closed by a cover.

2. The centrifuge (1) according to claim 1, wherein the open side (9a) of the drum housing (9) configured with the drum insert (7) is closed by a bag-shaped or hose-shaped closed foil (4), which is otherwise disengageable; and
the foil (4) is sized so that the drum insert (7) can be completely removed from the drum (2) and from the drum housing (9) within the foil (4) without removing the foil (4) from the drum housing (9), and the foil (4) can be closed tight between the drum housing (9) and the drum insert (7).

3. The centrifuge (1) according to claim 1, wherein the open side (9a) of the drum insert (7) is closed by a bag-shaped or hose-shaped closed foil (4), which is otherwise disengageable; and
the foil (4) is sized so that the drum insert (7) can be completely removed from the drum (2) and from the drum housing (9) inside the foil (4) without removing the foil (4) from the drum (2), and the foil (4) can be tightly sealed between the drum housing (9) and the drum insert (7) so that the foil (4) rotates with the drum (2).

4. The centrifuge (1) according to claim 1, wherein the inlet opening of the drum insert (7) comprises a connection spout (7a) which tightly fits onto the inlet (3) of the drum (2).

5. The centrifuge (1) according to claim 1, wherein the drum insert (7) is a reusable drum insert.

6. The centrifuge (1) according to claim 2, wherein the foil (4) is a thermoplastic foil (4).

7. The centrifuge (1) according to claim 1, wherein the rotational axis (20) of the drum (2) is disposed horizontally, and an open side (2a) is a face opposite to the inlet (3).

8. The centrifuge (1) according to claim 2, wherein the foil (4) is tightly mounted with its centrifuge oriented end at the drum housing (9) by means of a mounting device.

9. The centrifuge (1) according to claim 1, wherein the drum housing (9) comprises an outlet (6) for a centrifuged liquid.

10. The centrifuge (1) according to claim 1, wherein a washing device (11) having a spraying device (12) is provided in the drum housing (9).

11. The centrifuge (1) according to claim 1, wherein the drum housing (9) comprises a drying device for blowing in air or for loading with vacuum, and wherein the outlet (6) for the centrifuged liquid can be used alternatively as a supply opening for the drying air.

12. The centrifuge (1) according to claim 1, wherein multiple axial lengths of a sack- or hose-shaped foil (4) are stored on the drum housing (9) or on the drum (2) or on the drum insert (7), in particular on its outer circumference, than is required for tightly enveloping a removed drum insert (7).

13. The centrifuge (1) according to claim 1, wherein the centrifuge (1) comprises a cover hood that tightly fits onto the drum housing (9).

14. The centrifuge (1) according to claim 13, wherein the cover hood (5) comprises a disposal opening (13), at which a disposal bag is tightly mounted, which is comprised of a flexible foil sized axially long enough so that it can be moved forward toward the foil (4) or toward a residual foil (4′) at an open side of the drum housing (9) and so that it can be used as a glove.

15. The centrifuge (1) according to claim 14, wherein the disposal opening (13) is large enough for a fist to be inserted.

16. The centrifuge (1) according to claim 1, wherein the centrifuge (1) comprises a decontamination device (23) for placing onto a disposal opening (13).

17. A method for contamination free loading or emptying a centrifuge or a dryer, said method comprising the following steps:
a drum insert (7) fitting into a drum (2) or the centrifuge (1) is inserted into a drum housing (9) through an at least partially open or to be opened side (9a) of the drum housing (9) so that an inlet (3) of the drum insert (7) surrounding the drum (2) coincides with the inlet (3) of the drum (2);
an open side (2a) of the drum (2) is closed by tightly mounting the open side of an otherwise closed bag-shaped or hose-shaped foil (4) about the open side (2a); wherein
the foil (4) is sized so that the drum insert (7) can be completely removed from the drum (2) and the drum housing (9) within the foil (4) without removing the foil (4) from the drum (2), and the foil (4) can be closed tight between the drum housing (9) and the drum insert (7);
a suspension to be centrifuged is inducted into the drum insert (7) through the inlet (3) and thus into the drum (2), and both are jointly driven in rotation;
a liquid permeating the drum insert (7) towards the outside is removed from the drum housing (9);
the drum insert (7) with a filter cake (17) remaining therein is removed from the open side of the drum (2) and of the drum housing (9) with the foil (4) closed; and
the foil (4) is closed radially tight between the drum housing (9) and the drum insert (7) and separated at the closing location (19) or between the two closing locations (19a, b) so that only a residual foil (4′) remains at the drum housing (9).

18. The method according to claim 17, wherein the filter cake is dried in the drum insert (7) before removing the drum insert (7) and after termination of centrifuge operation, in particular through the supply of air, in particular the supply of dry air and/or heat into the drum housing (9), or through loading with vacuum, in particular at the outlet (6).

19. The method according to claim 17, wherein a cover hood (5) is placed over the foil (4) and over the drum housing (9) before centrifuging, therefore closing the drum housing (9) against components flying off, and the cover hood (5) is opened again before removing the drum insert (7) from the drum housing (9).

20. The method according to claim 17, wherein an interior of the drum housing (9) including the drum (2) is automatically cleaned by means of a washing device integrated in the drum housing (9) with the residual foil (4′) closed at the drum housing (9), and with a cover hood (5) put on tight, and the contaminated cleaning fluid being disposed through an outlet (6) of the drum housing (9);
said method may be performed plural times in sequence;
a residual foil (4′) is subsequently removed from the open side (9a) of the drum housing (9) and pulled into the interior of a disposal bag (14) by means of the disposal bag (14), tightly placed onto a disposal opening (13) in the cover hood (5), with the cover hood (5) tightly closed; and
the disposal bag (14) is sealed tight and separated between a disposal opening (13) and the residual foil (4′) so that the residual foil (4′) is received tight in a closed disposal bag (14′), which is only contaminated internally.

21. The method according to claim 20, wherein the residual foil (4′) is initially pulled off of the drum housing (9) for removing the contaminated residual foil (4′), so that the residual foil (4′) can be sealed tight and separated in an axial portion, which is no longer contaminated, before the residual foil is received in the disposal bag (14′).

22. The method according to claim 20, wherein a mounting device (18), which affixes the foil (4) or the residual foil (4′) tight at the drum housing (9) is disengaged through the disposal bag (14), which is being used as a glove.

23. The method according to claim 17, wherein separating the tightly closed foil (4) is performed so that a foil spout (21) protrudes from a closing location (19a) at the drum insert (7);
the protruding foil spout (21), which is disposed on the at least partially open face of the drum insert (7), is tightly connected to an outlet spout (15) for a filter cake (17);
the closing location (19a) of the foil (4) is opened;
the filter cake (17) is emptied from the drum insert (7) into the outlet spout (15) with the drum insert (7) positioned so that its open side is oriented downward; and
the foil (4) is sealed tight and separated between the drum insert (7) and the connection spout (15) after emptying the drum insert (7).

24. The method according to claim 23, wherein the emptied drum insert (7), which is received tight in the foil (4″), is fed into a cleaning device or a disposal device, which is tightly closed.
